(19) United States
(12) Patent Application Publication
(10) Pub. No.: US 2022/0045461 A1
(43) Pub. Date: Feb. 10, 2022

(54) Electronic Apparatus

(71) Applicant: KYOCERA Document Solutions Inc., Osaka-shi (JP)

(72) Inventors: Minoru SHINBA, Osaka-shi (JP); Yoshiaki TAMURA, Osaka-shi (JP)

(21) Appl. No.: 17/387,040

(22) Filed: Jul. 28, 2021

(30) Foreign Application Priority Data
Aug. 4, 2020 (JP) 2020-132683

(51) Int. Cl. H01R 13/645

(52) U.S. Cl. CPC H01R 13/645

(57) ABSTRACT

An internal unit of an electronic apparatus includes a receptacle to be inserted and removed successfully in any of two specific directions, and a controller circuit electrically connected to the receptacle. A cable includes a connector corresponding to the receptacle. When connecting the connector to the receptacle in one direction of the two specific directions without detecting the connection direction of the connector to the receptacle, the controller circuit successfully performs transmission of at least one of the signal and the power between the plurality of internal units. When connecting the connector to the receptacle in another direction of the two specific directions, the controller circuit does not successfully perform the transmission. The connector includes a connection direction restrictor that allows connection to the receptacle in the one direction and prohibits connection to the receptacle in the other direction.

### INCORPORATION BY REFERENCE

This application is based upon and claims the benefit of priority from the corresponding Japanese Patent Application No. 2020-132683 filed on Aug. 4, 2020, the entire contents of which are incorporated herein by reference.

### FIELD

The present disclosure relates to an electronic apparatus.

### BACKGROUND

A typical peripheral interface cable, such as a Type-C connector in the USB (Universal Serial Bus) 3.1 standard, has a connector that can be inserted and removed successfully in either the vertical direction (i.e., in either of two directions opposite to each other in a vertical plane with respect to the insertion and removal direction).

In another typical cable, only one of the two directions can be inserted and removed successfully, and the other direction is physically prohibited from being inserted and removed.

In a typical cable having a connector which can be successfully inserted and removed in any of the two directions as described above, symmetrical pin assignments are set in the connector and the receptacle so that the cable can be successfully transmitted even if the connector is connected in any of the two directions as described above, and an interface controller circuit connected to the receptacle includes a detection circuit such as a IC(Integrated Circuit) chip for detecting the direction of the connected connector, and transmits and receives signals and electric power according to the direction detected by the detection circuit.

On the other hand, in order to transmit signals and electric power between internal units in an electronic apparatus, it is conceivable to use an interface cable of a predetermined standard as described above as a transmission cable between internal units.

However, when the typical cable having a connector which can be successfully inserted and removed in any of the two directions as described above is used as a transmission cable between the internal units, it is necessary to provide the above-described detection circuit in the interface controller circuit, thereby increasing the cost of the electronic apparatus.

### SUMMARY

An electronic apparatus according to the present disclosure comprises a plurality of internal units and a cable for connecting the plurality of internal units. The internal unit comprises a receptacle to be inserted and removed successfully in any of two specific directions, and a controller circuit electrically connected to the receptacle. The cable includes a connector corresponding to the receptacle. When connecting the connector to the receptacle in one direction of the two specific directions without detecting the connection direction of the connector to the receptacle, the controller circuit successfully performs transmission of at least one of the signal and the power between the plurality of internal units. When connecting the connector to the receptacle in another direction of the two specific directions, the controller circuit does not successfully perform the transmission. The connector includes a connection direction restrictor that allows connection to the receptacle in the one direction and prohibits connection to the receptacle in the other direction.

### BRIEF DESCRIPTION OF FIGURES

FIG. 1 is a block diagram showing a configuration of an electronic apparatus according to an embodiment of the present disclosure.

FIG. 2 is a side view showing an example of the connector portion 13-i in a first embodiment.

FIG. 3 is a side view showing an example of the connector 22 in a second embodiment.

FIG. 4 is a plan view showing an example of the connector portion 13-i in a third embodiment.

FIG. 5 is a plan view showing an example of the connector portion 13-i in a fourth embodiment.

### DETAILED DESCRIPTION

Embodiments of the present disclosure will be described below with reference to the drawings.

### Embodiment 1

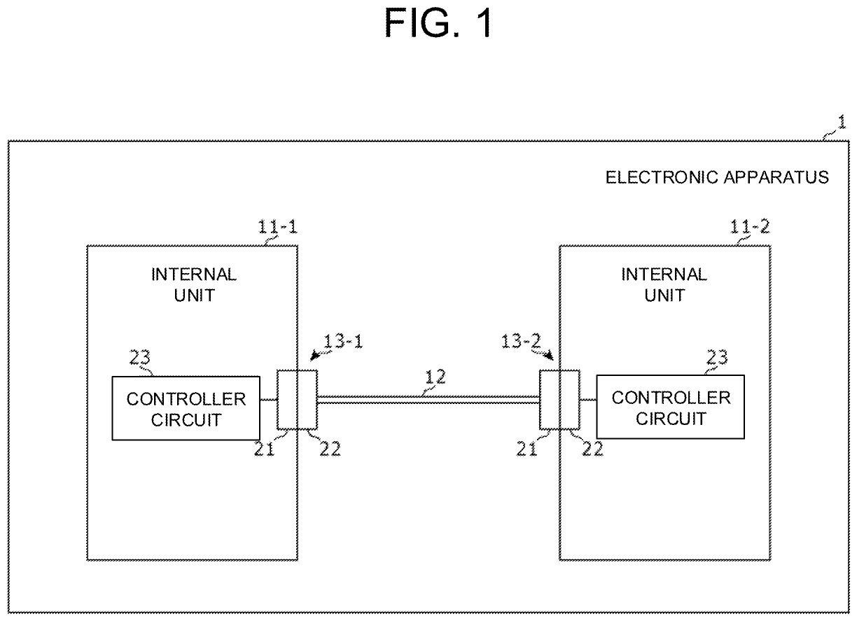

FIG. 1 is a block diagram showing a configuration of an electronic apparatus according to an embodiment of the present disclosure. The electronic apparatus 1 shown in FIG. 1 includes a plurality of internal units 11-1 and 11-2 having a plurality of functions, respectively, and a cable 12 for electrically connecting the internal units 11-1 and 11-2 to each other. The cable 12 and the internal units 11-1 and 11-2 are detachably physically and electrically connected by the connector portions 13-1 and 13-2. The connector portion 13-i (i=1, 2, . . . , M, M>1) includes a receptacle 21 provided in the internal unit 11-i and a connector 22 provided in the cable 12.

For example, the electronic apparatus 1 is an image forming apparatus such as a printer or a multifunction machine, and the internal unit 11-i is an electronic circuit board having a controller or the like, a printing unit, an image reading unit, or the like.

The receptacle 21 in each internal unit 11-i is a receptacle of a predetermined connector standard designed to be successfully inserted and removed in any of two specific directions (i.e., the two specific directions are different from each other by 180 degrees, generally in an upward and downward direction). The connector 22 is a connector of a predetermined connector standard corresponding to the receptacle 21. In the first embodiment, the predetermined connector standard is USB Type-C. Therefore, the receptacle 21 and the connector 22 are made of general-purpose products of the above standard.

However, in this embodiment, the cable 12 is a custom cable for efficient transmission and transmits signals with pin assignments different from those of the connector standard described above. For example, in a typical USB Type-C cable, power and ground are assigned to portions of 24 pins and 24 lines, while in cable 12 all pins and lines are used for transmission of multiple signals (i.e. more signals than in a USB Type-C cable).

Each internal unit 11-i further includes a controller circuit 23 electrically connected to the receptacle 21.

The controller circuit 23 is not provided with the detection circuit described above, and is configured so that if the connector 22 is connected to the receptacle 21 in one of its specific two directions without detecting the connection direction of the connector 22 with respect to the receptacle 21, transmission of at least one of the signal and power between the plurality of internal units 11-i will be successful, and that such transmission will not be successful even if the connector 22 is connected to the receptacle 21 in the other of its specific two directions. That is, the controller circuit 23 always performs the above-described communication control for transmission on the assumption that the connector 22 is connected to the receptacle 21 in the above-described one direction (in such a state that the pin assignment of the receptacle 21 is uniquely set).

Thus, connector 22 includes a connection direction restrictor that allows connection to receptacle 21 in one direction as described above and physically (mechanically) prohibits connection to receptacle 21 in the other direction as described above.

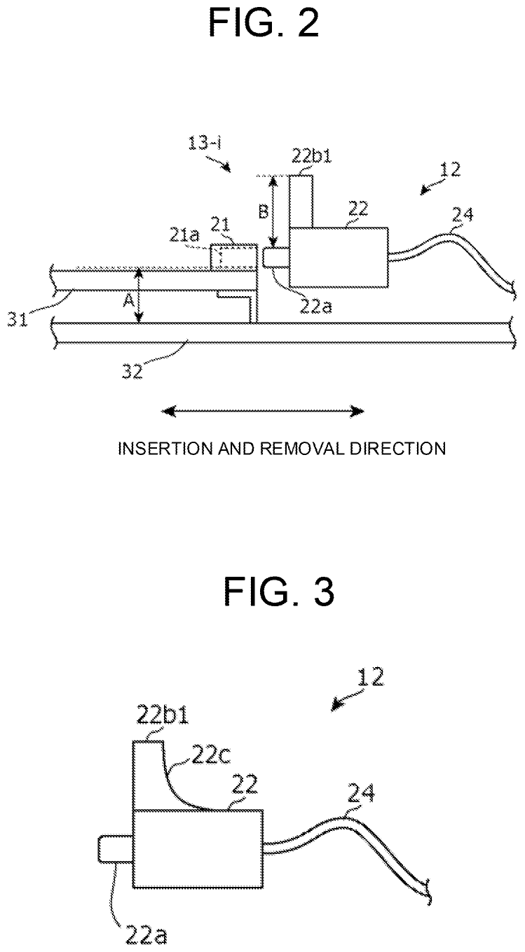

FIG. 2 is a side view showing an example of the connector portion 13-i in the first embodiment. For example, as shown in FIG. 2, in the first embodiment, in the cable 12, a connector 22 is provided at an end portion of the electric wire 24, and the connector 22 is provided with a terminal portion 22a electrically connected to the receptacle 21 and a protrusion 21b1 as the connection direction restrictor. The terminal portion 22a extends in the insertion and removal direction of the receptacle 21 and the connector 22, and the protrusion 21b1 extends in the vertical direction with respect to the insertion and removal direction.

The protrusion 21b1 may be formed integrally with the main body of the connector 22, or may be a member different from the main body of the connector 22 and fixed to the main body of the connector 22.

In the first embodiment, the receptacle 21 is fixedly mounted on the circuit board 31 in the internal unit 11-i, and the circuit board 31 is fixed to be apart from the internal unit 11-i or the structure 32 (metal sheet, resin housing, etc.) of the electronic apparatus 1 by a predetermined distance.

When the connector 22 is to be connected to the receptacle 21 in the other direction described above, the protrusion 21b1 of the connector 22 interferes with the structure 32, thereby preventing the connector 22 from being connected to the receptacle 21 in the other direction, and when the connector 22 is to be connected to the receptacle 21 in the one direction described above, the protrusion 21b1 of the connector 22 does not interfere with the structure 32.

That is, the length of the protrusion 21b1 is such that, when the connector 22 is inserted into the receptacle 21 with the protrusion 21b1 facing the structure 32 (i.e. in the direction opposite to the direction shown in FIG. 2), the protrusion 21b1 interferes with the structure 32 and cannot be inserted.

On the other hand, the connector 22 is not provided with any protrusion at the outer peripheral portion of the connector 22 opposite to the protrusion 21b1, and the connector 22 has a shape in which the connector 22 can be inserted into the receptacle 21 without interfering with the structure 32 when the connector 22 is inserted into the receptacle 21 in the direction shown in FIG. 2.

Specifically, the length of the protrusion 21b1 is determined so that the distance A from the terminal portion 21a of the receptacle 21 (the portion engaged with and electrically connected to the terminal portion 22a of the connector 22) to the structure 32 is shorter than the distance B from the terminal portion 22a of the connector 22 to the protrusion 21b1.

As described above, according to the first embodiment described above, the internal unit 11-i includes a receptacle 21 of a predetermined connector standard designed to be successfully inserted and removed in any of two specific directions, and a controller circuit 23 electrically connected to the receptacle 21. The cable 12 connecting the internal unit 11-i includes a connector 22 of a predetermined connector standard corresponding to the receptacle 21. When the connector 22 is connected to the receptacle 21 in one of the two specific directions without detecting the connection direction of the connector 22 with respect to the receptacle 21, the controller circuit 23 successfully transmits at least one of the signal and the power between the internal units 11-i, and when the connector 22 is connected to the receptacle 21 in the other of the two specific directions, the controller circuit 23 does not successfully transmit the signal and the power, and the connector 22 is provided with a protrusion 21b1 that allows connection to the receptacle 21 in the one direction and prohibits connection to the receptacle 21 in the other direction.

As a result, the above-described detection circuit becomes unnecessary, and the electronic apparatus 1 can be obtained at a relatively low cost even if the connector portion 13-i designed to be successfully inserted and removed in any of the two directions according to the predetermined standard is used internally. Since the cable 12 is installed in the electronic apparatus 1 and is not inserted or removed by the user, there is no problem in usability even if the connection direction is limited in this way. Further, since the above-described cable 12 as a high-performance custom cable can be developed using a standard capable of high-speed communication such as a USB Type-C cable and using an existing standard for the connector portion 13-i, the development work can be reduced.

### Embodiment 2

FIG. 3 is a side view showing an example of the connector 22 in the second embodiment. In the second embodiment, the protrusion 21b1 of the connector 22 increases in thickness from the tip toward the main body of the connector 22 to form a curved surface 22c. This makes it easy for a worker to attach a finger to the curved surface 22c and connect the connector 22 to the receptacle 21 when manufacturing the electronic apparatus 1.

Since the other configuration of the electronic apparatus 1 according to the second embodiment is the same as that of the first embodiment, a description thereof will be omitted.

### Embodiment 3

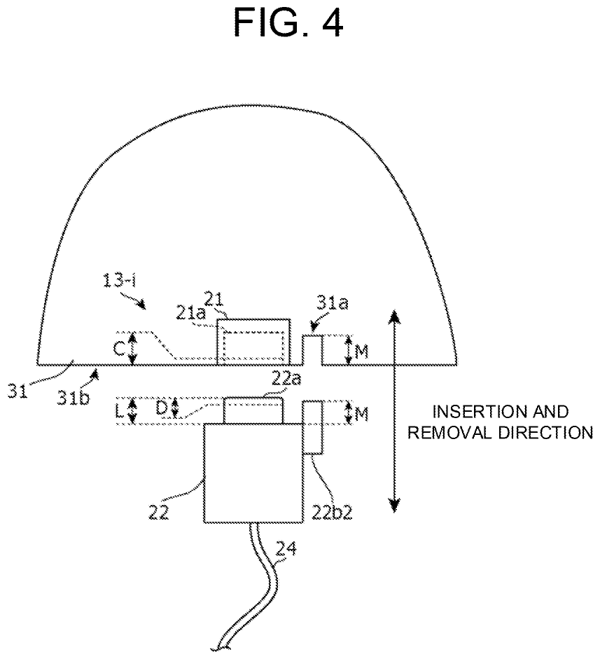

FIG. 4 is a plan view showing an example of the connector portion 13-i in the third embodiment. For example, as shown in FIG. 4, in the third embodiment, the connector 22 is provided with the above-described terminal portion 22a and the above-described protrusion 22b2 as the connection direction restrictor. The protrusion 22b2 extends in the insertion and removal direction described above.

In the third embodiment, the protrusion 22b2 of the connector 22 interferes with the circuit board 31 of the internal unit 11-i when the connector 22 is to be connected to the receptacle 21 in the other direction, thereby inhibiting the connection to the receptacle 21 in the other direction, and does not interfere with the circuit board 31 when the connector 22 is to be connected to the receptacle 21 in the one direction.

The protrusion 22b2 may be formed integrally with the main body of the connector 22, or may be a member different from the main body of the connector 22 and fixed to the main body of the connector 22.

In the third embodiment, the circuit board 31 includes a recess 31a. For example, as shown in FIG. 4, the recess 31a is formed in the end portion 31b of the circuit board 31 on which the receptacle 21 is provided. In the third embodiment, the receptacle 21 is placed in a position in in the circuit board 31 such that, when the connector 22 is connected to the receptacle 21 in the one direction, the protrusion 22b2 is placed in the recess 31a, and when the connector 22 is connected to the receptacle 21 in the other direction, the protrusion 22b2 interferes with the end portion 31b of the circuit board 31.

That is, the recess 31a of the circuit board 31 is formed at a position and a shape such that, (a) when the connector 22 is to be inserted into the receptacle 21 in such a manner that the direction of the recess 31a as seen from the receptacle 21 coincides with the direction of the protrusion 22b2 as seen from the terminal portion 22a (i.e. in the direction shown in FIG. 2), the protrusion 22b2 is inserted without interfering with the circuit board 31, and (b) when the connector 22 is to be inserted into the receptacle 21 in such a manner that the direction of the recess 31a as seen from the receptacle 21 is opposite to the direction of the protrusion 22b2 as seen from the terminal portion 22a (i.e. in the direction opposite to the direction shown in FIG. 2), the protrusion 22b2 interferes with the end portion 31b of the circuit board 31 and cannot be inserted (because there is no recess provided in the opposite side).

In the third embodiment, for example, the depth of the recess 31a and the length of the tip of the protrusion 22b2 are set to the minimum necessary length M. M is determined by the following equation:

M=L−(C+D).

Where L is the length of the terminal portion 22a, C is the distance from the tip of the receptacle 21 and the circuit board 31 to the terminal portion 21a, and D is the distance from the tip of the terminal portion 22a to the contact in the terminal portion 22a (i.e., the portion actually electrically connected to the terminal portion 21a of the receptacle 21). That is, C and D are distances from the start of the mechanical connection to the start of the electrical connection when the connector 22 is connected to the receptacle 21.

Since the other configuration of the electronic apparatus 1 according to the third embodiment is the same as that of the first or second embodiment, a description thereof will be omitted.

### Embodiment 4

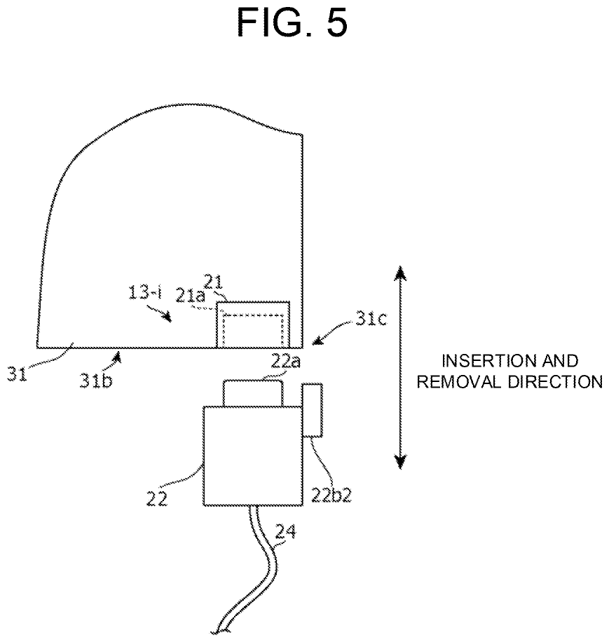

FIG. 5 is a plan view showing an example of the connector portion 13-i in the fourth embodiment. For example, as shown in FIG. 4, although the same cable 12 as in the third embodiment is used in the fourth embodiment, the receptacle 21 is provided at a position different from the third embodiment in the circuit board 31.

Specifically, in the fourth embodiment, the receptacle 21 is provided in a position in the circuit board 31 such that, when the connector 22 is connected to the receptacle 21 in the one direction, the protrusion 22b2 is arranged outside the corner portion 31c of the circuit board 31 as viewed from the receptacle 21, and when the connector 22 is connected to the receptacle 21 in the other direction, the protrusion 22b2 interferes with the end portion 31b of the circuit board 31. Therefore, in the fourth embodiment, it is not necessary to form the recess 31a in the circuit board 31.

Since the other configuration of the electronic apparatus 1 according to the fourth embodiment is the same as that of any one of the first to third embodiments, a description thereof will be omitted.

Various changes and modifications to the foregoing embodiments will be apparent to those skilled in the art. Such changes and modifications may be made without departing from the spirit and scope of the subject matter and without diminishing the intended benefits. That is, such changes and modifications are intended to be included in the claims.

What is claimed is:

1. An electronic apparatus comprising:
a plurality of internal units; and
a cable for connecting the plurality of internal units,
the internal unit including a receptacle to be inserted and removed successfully in any of two specific directions, and a controller circuit electrically connected to the receptacle,
the cable including a connector corresponding to the receptacle,
wherein, when connecting the connector to the receptacle in one direction of the two specific directions without detecting a connection direction of the connector with respect to the receptacle, the controller circuit successfully performs transmission of at least one of a signal and a power between the plurality of internal units, and when connecting the connector to the receptacle in an other direction of the two specific directions, the controller circuit does not successfully perform the transmission, and
wherein the connector includes a connection direction restrictor that allows connection to the receptacle in the one direction and prohibits connection to the receptacle in the other direction.

2. The electronic apparatus according to claim 1, wherein
the connection direction restrictor is a protrusion provided on the connector, and
the protrusion, by interfering with the internal unit or a structure of the electronic apparatus when connecting the connector to the receptacle in the other direction, prohibits the connection to the receptacle in the other direction, and does not interfere with the internal unit or the structure of the electronic apparatus when connecting the connector to the receptacle in the one direction.

3. The electronic apparatus according to claim 1, wherein
the connection direction restrictor is a protrusion provided on the connector, and
the protrusion, by interfering with a circuit board of the internal unit when connecting the connector to the receptacle in the other direction, prohibits the connection to the receptacle in the other direction, and does not interfere with the circuit board of the internal unit when connecting the connector to the receptacle in the one direction.

4. The electronic apparatus according to claim 3, wherein
the circuit board includes a recess, and
the receptacle is provided in a position in the circuit board such that, the protrusion is placed in the recess when connecting the connector to the receptacle in the one direction, and the protrusion interferes with an end portion of the circuit board when connecting the connector to the receptacle in the other direction.

5. The electronic apparatus according to claim 3, wherein
the receptacle is provided in a position in the circuit board such that, when connecting the connector to the receptacle in the one direction, the protrusion is placed outside a corner portion of the circuit board as viewed from the receptacle, and when connecting the connector to the receptacle in the other direction, the protrusion interferes with an end portion of the circuit board.
